(19) United States
(12) Patent Application Publication
(10) Pub. No.: US 2021/0191120 A1
(43) Pub. Date: Jun. 24, 2021

(54) HEAD-UP DISPLAY FOR VEHICLE HAVING IMPROVED COUPLING STRUCTURE

(71) Applicant: HYUNDAI MOBIS Co., Ltd., Seoul (KR)

(72) Inventors: Byung Ki KIM, Yongin-si (KR); Chan Seo GOO, Suwon-si (KR)

(21) Appl. No.: 17/121,566

(22) Filed: Dec. 14, 2020

(30) Foreign Application Priority Data
Dec. 20, 2019 (KR) 10-2019-0172513

(51) Int. Cl. G02B 27/01; G02B 7/182; G02B 5/10; B60K 35/00

(52) U.S. Cl. CPC G02B 27/0101; G02B 7/1821; G02B 5/10; B60K 2370/816; B60K 2370/1529; B60K 2370/66; B60K 35/00

(57) ABSTRACT

A head-up display for a vehicle having an improved coupling structure between a screen, and a folding mirror and an aspheric mirror. The head-up display for a vehicle according to one embodiment of the present invention includes a screen and a folding mirror snap-fit-coupled and fixed to the screen.

### CROSS-REFERENCE TO RELATED APPLICATION

This application claims priority from and the benefit of Korean Patent Application No. 10-2019-0172513, filed on Dec. 20, 2019, which is hereby incorporated by reference for all purposes as if set forth herein.

### BACKGROUND

### Field

Exemplary embodiments relate to a head-up display for a vehicle, and more particularly, to a head-up display device for a vehicle having an improved coupling structure between a screen, and a folding mirror and an aspheric mirror.

### Discussion of the Background

In recent years, the automobile market is rapidly growing with the trend of favoring intelligent vehicles equipped with advanced information technology (IT) and convenient functions as well as the improvement of original functions of vehicles. In such a trend, with the spreading of the electronic equipment of vehicles, functions, in which IT and wireless communication technology are integrated, are rapidly increasing.

In particular, products that support the driver's stability and convenience are being released, and as one of the products, a head-up display (HUD) for a vehicle is attracting attention as a variety of product lines.

In general, a vehicle head-up display is a device that displays an image including vehicle speed, a fuel level, road guidance information, and the like on a windshield that is a front window of a vehicle.

Among components constituting such a vehicle head-up display, a folding mirror may be deformed according to a push position and a push force for the folding mirror, and image distortion may occur due to the deformation thereof.

On the other hand, in the conventional aspheric mirror mounting structure, one side of an elastic body for pressing a spherical mount portion has a hook shape, and the other side thereof often has a shape for screw coupling.

Such a structure has a problem in that a gap may occur in an aspheric mirror due to permanent deformation of an elastic body when an unexpected large impact or the like is applied to the aspheric mirror.

The above information disclosed in this Background section is only for enhancement of understanding of the background of the invention and, therefore, it may contain information that does not constitute prior art.

### SUMMARY

Exemplary embodiments of the present invention provide an improved coupling structure between a screen, and a folding mirror, and an aspheric mirror, thereby preventing deformation of the folding mirror and allowing a spherical mount of the aspheric mirror to maintain a fixing force.

Additional features of the invention will be set forth in the description which follows, and in part will be apparent from the description, or may be learned by practice of the invention.

An exemplary embodiment of the present invention provides a head-up display for a vehicle having an improved coupling structure including a screen, and a folding mirror snap-fit-coupled to the screen.

The screen may include an opening formed to pass through a portion thereof connected to the folding mirror, stoppers disposed around the opening to hold side surfaces of the folding mirror, and fixing holders disposed at peripheries of the stoppers to hold an upper surface, a lower surface, and a side surface of the folding mirror.

A portion of the fixing holder may protrude inward toward the opening and may be forcibly fitted into the folding mirror.

The fixing holder may have a “ [symbol] ” shape in which an upper end thereof is gradually inclined toward a lower portion thereof.

The fixing holder may have a shape in which an upper end thereof is gradually inclined toward a lower portion thereof, and a portion thereof configured to hold the folding mirror may be formed in a “⊏” shape so as to fix a side end of the folding mirror.

The fixing holder may include an upper frame configured to hold the upper surface of the folding mirror, a side frame configured to hold the side surface of the folding mirror, and a lower frame configured to hold the lower surface of the folding mirror.

An upper end of the upper frame may have a chamfered structure.

Another exemplary embodiment of the present invention provides a head-up display for a vehicle having an improved coupling structure including a screen and a folding mirror cover snap-fit-coupled to the screen, and a folding mirror fixed between the screen and the folding mirror cover.

The screen may include an opening of which one side is open, stoppers disposed around the opening and in contact with the folding mirror, and connection parts disposed at peripheries of the stoppers and coupled to the folding mirror cover through concave-convex coupling.

The connection part may include a fixing step formed to protrude outward and a grip member formed to protrude at a periphery of the fixing step.

The folding mirror cover may include a fixing latch fitted on and coupled to the fixing step and a fixing bar fitted into and coupled to the grip member.

The screen may further include seating surfaces which are disposed between the opening and the stoppers and are in surface contact with lower surfaces of side ends of the folding mirror.

The folding mirror cover may include a pushing member formed at a position facing the seating surface and in surface contact with the folding mirror.

The folding mirror cover may have a fixing hole formed to pass therethrough at a position corresponding to the seating surface, and the pushing member may be connected to a lower end of the fixing hole and may reciprocate in a forward direction toward the seating surface and a rearward direction opposite to the seating surface.

The pushing member may include a fixing part connected to the lower end of the fixing hole, and a pressing part which is formed to extend from the fixing part and reciprocates in the forward and backward directions of the fixing hole in a state of being fixed to the fixing hole.

The pressing part may be in surface contact with the folding mirror.

Another exemplary embodiment of the present invention provides a head-up display for a vehicle having an improved coupling structure including a lower case, an aspheric mirror including spherical mounts formed at both ends thereof so as to be rotatably connected to the lower case, and a screen connected to the lower case and including a leaf spring configured to limit a displacement of the spherical mount with a predetermined fixing force.

The lower case may include a vertical coupling groove having a height relatively greater than a diameter of the spherical mount, and the vertical coupling groove may be bolt-coupled to the screen.

The leaf spring may fix the spherical mount by protruding in a direction, in which the leaf spring is in contact with the spherical mount, by as much as a difference between the height of the vertical coupling groove and the diameter of the spherical mount.

The leaf spring may have a snap-fit coupling structure detachably coupled to a coupling hole formed in the screen.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic view for describing a head-up display for a vehicle according to a first embodiment of the present invention.

FIG. 2 is a view illustrating a screen in the head-up display for a vehicle according to the first embodiment of the present invention.

FIG. 3 is a view illustrating a coupling state between the screen and a folding mirror in the head-up display for a vehicle according to the first embodiment of the present invention.

FIGS. 4A to 4C are views illustrating a process in which the folding mirror is mounted on the screen in the head-up display for a vehicle according to the first embodiment of the present invention.

FIG. 5 is a view illustrating a fixing holder of the screen for fixing the folding mirror in the head-up display for a vehicle according to the first embodiment of the present invention.

FIG. 6 is a view illustrating a push structure of the fixing holder for fixing the folding mirror in the head-up display for a vehicle according to the first embodiment of the present invention.

FIG. 7 is a schematic view illustrating a folding mirror cover for fixing a folding mirror and a screen in a head-up display for a vehicle according to a second embodiment of the present invention.

FIG. 8 is a view illustrating a reference position of the folding mirror mounted on the screen in the head-up display for a vehicle according to the second embodiment of the present invention.

FIGS. 9 to 13 are views illustrating a state in which the folding mirror cover and the screen are coupled to each other with the folding mirror interposed therebetween in the head-up display for a vehicle according to the second embodiment of the present invention.

FIG. 14 is a view illustrating the screen in the head-up display for a vehicle according to the second embodiment of the present invention.

FIG. 15 is a view illustrating the folding mirror cover in the head-up display for a vehicle according to the second embodiment of the present invention.

FIGS. 16 and 17A to 17C are views illustrating a mounting state between an aspheric mirror and a lower case in a head-up display for a vehicle according to a third embodiment of the present invention.

FIGS. 18 and 19A to 19B are views illustrating a state in which a leaf spring is mounted on a screen in the head-up display for a vehicle according to the third embodiment of the present invention.

FIG. 20 is a view illustrating a state in which the screen mounted with the leaf spring and the lower case are coupled to each other with the aspheric mirror interposed therebetween in the head-up display for a vehicle according to the third embodiment of the present invention.

### DETAILED DESCRIPTION OF THE ILLUSTRATED EMBODIMENTS

The advantages and features of the present invention and methods for accomplishing the same will be more clearly understood from embodiments to be described in detail below with reference to the accompanying drawings. However, the present invention is not limited to the following embodiments but may be implemented in various different forms. Rather, these embodiments are provided only to complete the disclosure of the present invention and to allow those skilled in the art to understand the category of the present invention. The present invention is defined by the category of the claims. Meanwhile, terms used in this specification are to describe the embodiments and are not intended to limit the present invention. As used herein, singular expressions, unless defined otherwise in context, include plural expressions. It will be further understood that the terms “comprises,” “comprising,” “includes,” and/or “including,” when used herein, specify the presence of stated components, steps, operations, and/or elements, but do not preclude the presence or addition of one or more other components, steps, operations, and/or elements.

A head-up display for a vehicle according to the present invention is basically provided in a vehicle and is installed at a lower portion of a windshield. In the present invention, a coupling structure between components of such a head-up display for a vehicle will be described through first to third embodiments.

Accordingly, components related to the features of the present invention will be mainly described, and components separate from the features will be omitted.

Hereinafter, exemplary embodiments of the present invention will be described in detail with reference to the accompanying drawings.

### First Embodiment

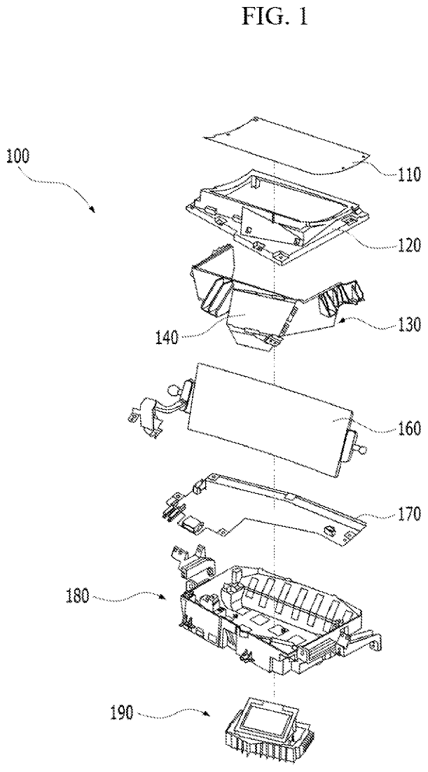

FIG. 1 is a schematic view for describing a head-up display for a vehicle according to a first embodiment of the present invention.

Referring to FIG. 1, a head-up display 100 for a vehicle is a device that provides head-up display (HUD) information (vehicle operation information such as vehicle driving information or navigation information) within a range that does not deviate from a driver's front visual field, that is, a driver's main visual field.

The head-up display 100 for a vehicle includes a cover lens 110, an upper case 120, a screen 130, a folding mirror 140, an aspheric mirror 160, a board assembly 170, a lower case 180, and a light-emitting diode (LED) assembly 190.

Here, the head-up display 100 for a vehicle according to the first embodiment relates to a coupling structure between the screen 130 and the folding mirror 140 and has a structure that does not require a folding mirror cover (not shown in FIG. 1).

Accordingly, the head-up display 100 for a vehicle according to the first embodiment provides an improved coupling structure by applying a snap-fit structure between the screen 130 and the folding mirror 140.

In addition, in the first embodiment, the separate folding mirror cover is not required to fix the folding mirror 140, thereby reducing costs.

Furthermore, descriptions of general components constituting the head-up display 100 for a vehicle will be omitted, and the screen 130 and the folding mirror 140 featured in the first embodiment will be described with reference to the accompanying drawings.

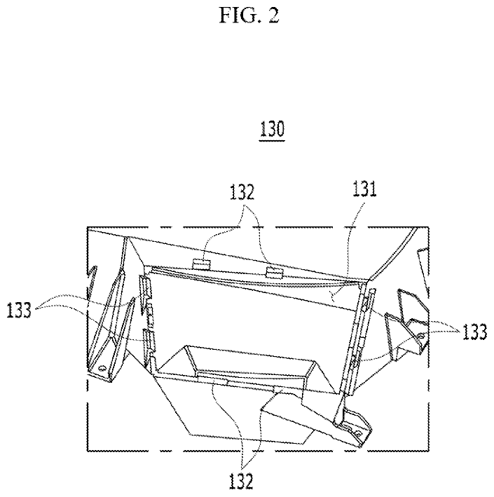

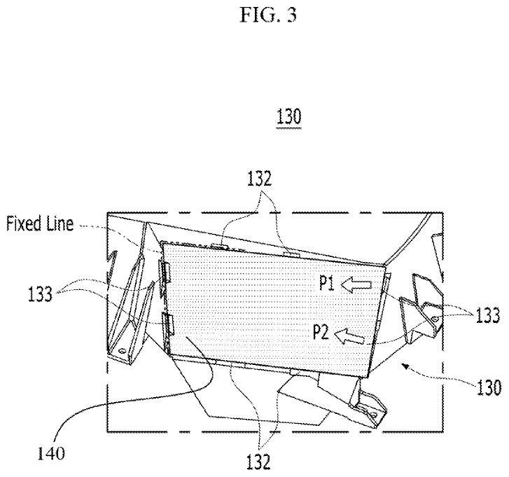

FIG. 2 is a view illustrating the screen in the head-up display for a vehicle according to the first embodiment of the present invention, and FIG. 3 is a view illustrating a coupling state between the screen and the folding mirror.

Referring to FIGS. 2 and 3 together, the screen 130 is connected to the folding mirror 140 in a snap-fit coupling structure. In this case, the screen 130 includes an opening 131, stoppers 132, and fixing holders 133.

The opening 131 is formed to pass through a portion connected to the folding mirror 140. In this case, the opening 131 has a width relatively smaller than a width of the folding mirror 140. This is to seat side ends of the folding mirror 140.

Here, the width of the opening 131 refers to a size within a range that does not limit a reflection path of the folding mirror 140.

The stoppers 132 are provided to hold side surfaces of the folding mirror 140 around the opening 131. In this case, in terms of fixing the folding mirror 140, the plurality of stoppers 132 may be formed at intervals.

The interval between the stoppers 132 may correspond to the width of the folding mirror 140.

The plurality of fixing holders 133 are disposed at peripheries of the stoppers 132. The fixing holder 133 has a structure in which a portion of the fixing holder 133 protrudes inward toward the opening 131 so that the folding mirror 140 is forcibly fitted into the fixing holder 133.

The fixing holders 133 hold upper, lower, and side surfaces of the folding mirror 140. This is to prevent the deformation of the folding mirror 140.

As a result, the fixing holders 133 effectively fix the three surfaces (upper, lower, and side surfaces) of the folding mirror 140 to prevent the deformation of the folding mirror 140.

Describing the fixing holders 133 in a direction shown in FIG. 3, the fixing holders 133 disposed at a right side push and fix the folding mirror 140 in two push directions P1 and P2.

In this case, the folding mirror 140 pushed from the fixing holders 133 at the right side is fixed in a fixed line in which the fixing holders 133 at a left side are disposed.

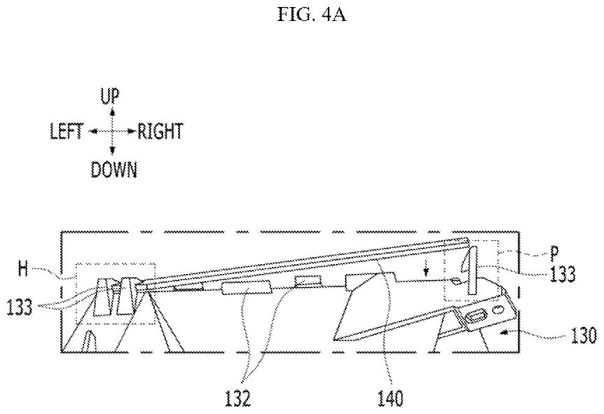

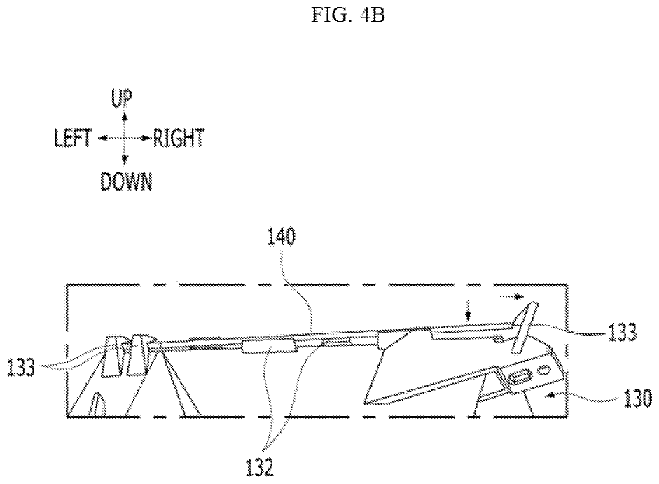

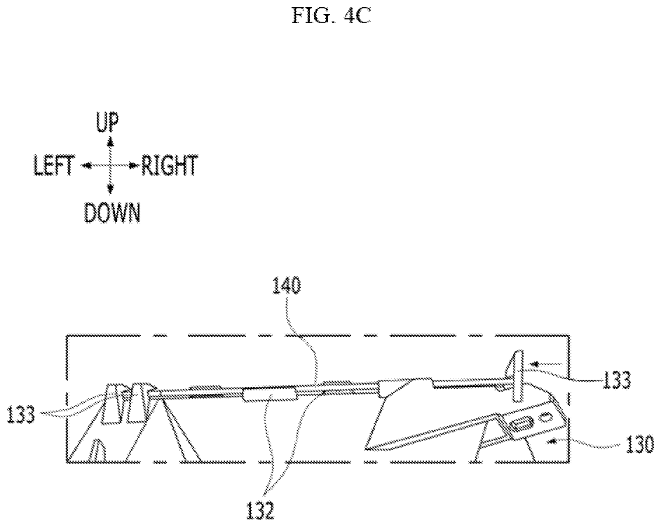

FIG. 4 is a view illustrating a process in which the folding mirror is mounted on the screen in the head-up display for a vehicle according to the first embodiment of the present invention.

Referring to FIGS. 4A to 4C, in a state in which the folding mirror 140 is fitted into the left fixing holders 133 of the screen 130, the folding mirror 140 is moved downward so as to be fitted into the right fixing holders 133.

Here, the fixing holders 133 may be divided into push portions P formed at an interval at one side (right side) to fix the folding mirror 140 and holder portions H formed at an interval at the other side (left side) to seat the folding mirror 140.

In this case, the folding mirror 140 has a structure in which the folding mirror 140 is fixed by being pushed leftward from the push portions P in a state of being seated in the holder portions H.

That is, the fixing holder 133 pushes the folding mirror 140 in a direction from one (right) side to the other (left) side to fix the folding mirror 140.

The fixing holder 133 may have a “ [symbol] ” shape in which an upper end thereof is gradually inclined toward a lower portion thereof. This is to enable the folding mirror 140 to be forcibly fixed into the fixing holder 133 smoothly.

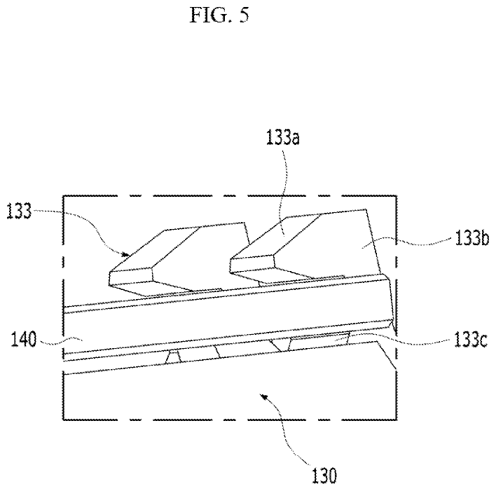

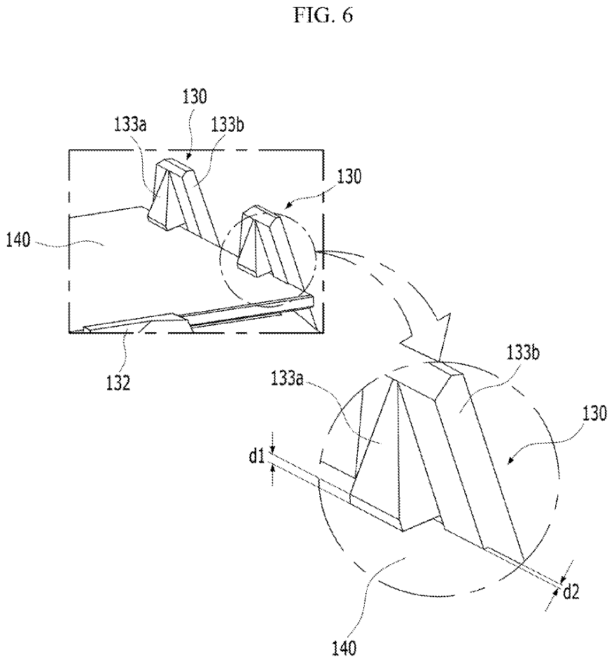

FIG. 5 is a view illustrating the fixing holder of the screen for fixing the folding mirror in the head-up display for a vehicle according to the first embodiment of the present invention, and FIG. 6 is a view illustrating a push structure of the fixing holder for fixing the folding mirror.

Referring to FIGS. 5 and 6 together, the fixing holder 133 has a shape in which the upper end is gradually inclined toward the lower portion. This is to enable the folding mirror 140 to be moved from an upper portion to the lower portion of the fixing holder 133 and forcibly fitted into the fixing holder 133.

In this case, in the fixing holder 133, an (inner) portion thereof for holding the folding mirror may be formed in a “ [symbol] ” shape so as to fix a side end of the folding mirror 140.

Here, the fixing holder 133 may include an upper frame 133a, a side frame 133b, and a lower frame 133c.

The upper frame 133a is a section that holds an upper surface of the folding mirror 140 and has a chamfered structure.

A lower end of the upper frame 133a may be in surface contact with the upper surface of the folding mirror 140. Accordingly, the lower end of the upper frame 133a is parallel to the upper surface of the folding mirror 140.

As a result, the upper frame 133a can firmly seat the upper surface of the folding mirror 140 so as to not be shaken.

The side frame 133b is a section that holds the side surface of the folding mirror 140.

The lower frame 133c is a section that holds a lower surface of the folding mirror 140. In this case, the lower frame 133c is formed in a flat shape like the upper frame 133a.

Accordingly, the fixing holders 133 may stably seat and fix the upper surface, the side surface, and the lower surface of the folding mirror 140. As a result, the fixing holder 133 can prevent the deformation of the folding mirror 140.

As shown in FIG. 6, the fixing holder 133 can secure an overlap amount according to the push form thereof. Here, the overlap amount refers to an allowable displacement amount of the fixing holder 133.

Since the fixing holder 133 has a structure that pushes and fixes the folding mirror 140, it is possible to secure an upper surface overlap amount d1 and a side surface overlap amount d2.

### Second Embodiment

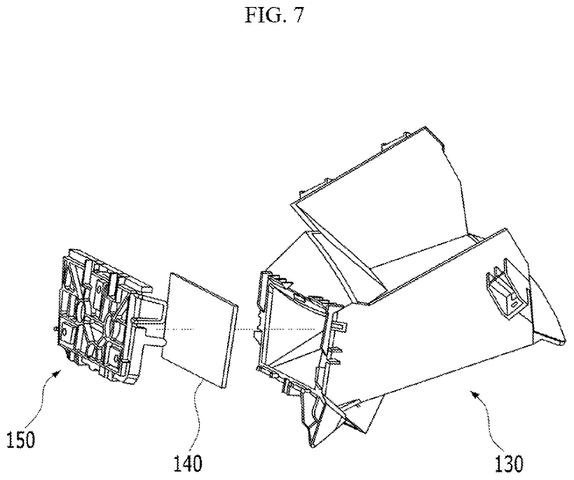

FIG. 7 is a schematic view illustrating a folding mirror cover for fixing a folding mirror and a screen in a head-up display for a vehicle according to a second embodiment of the present invention.

Referring to FIG. 7, unlike the first embodiment, a folding mirror cover 150 is applied to the second embodiment of the present invention. The folding mirror cover 150 is snap-fit-coupled to a screen 130 with a folding mirror 140 interposed therebetween.

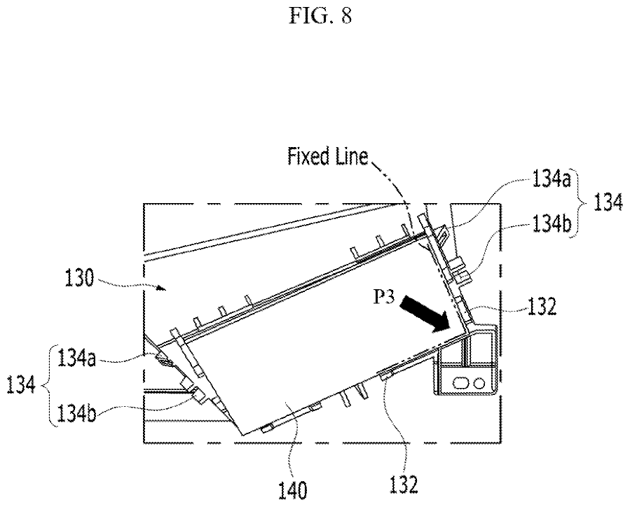

FIG. 8 is a view illustrating a reference position of the folding mirror mounted on the screen in the head-up display for a vehicle according to the second embodiment of the present invention.

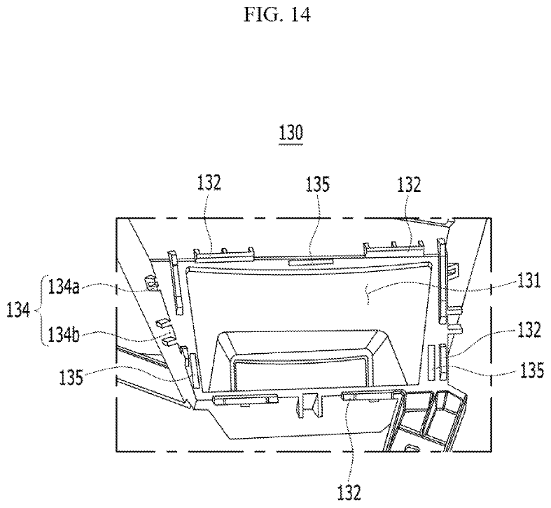

Referring to FIG. 8, the screen 130 includes stoppers 132 that are disposed around an opening (see 131 of FIG. 14) and are in contact with the folding mirror 140.

The stoppers 132 serve to fix side surfaces of the folding mirror 140 and provide a reference position for mounting the folding mirror 140.

That is, when the folding mirror 140 is pushed in a side push direction P3, the stopper 132 fixes the side surface of the folding mirror 140.

The screen 130 includes connection parts 134 formed at a periphery of the stopper 132.

In this case, the connection part 134 includes a fixing step 134a and a grip member 134b.

The fixing step 134a is formed to protrude outward from the opening.

The grip member 134b is formed to protrude from a periphery of the fixing step 134a. The grip member 134b is formed in a “ [symbol] ” shape and has a structure that allows an object to be surrounded.

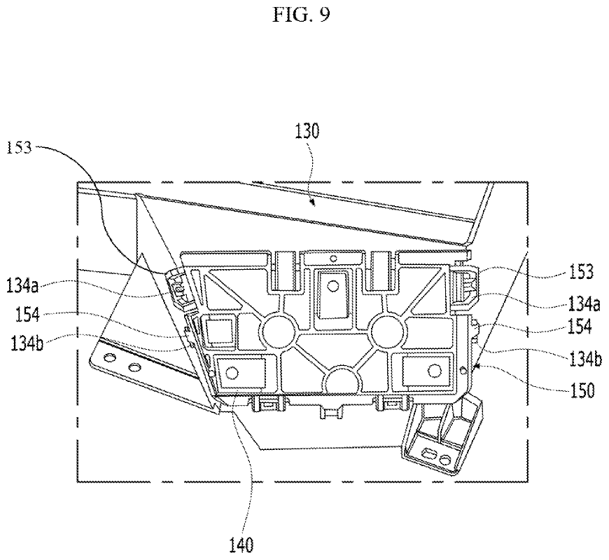

The connection part 134 is coupled with the folding mirror cover (see 150 of FIG. 9) to be described through concave-convex coupling. Such a coupling relationship will be described with reference to the accompanying drawings.

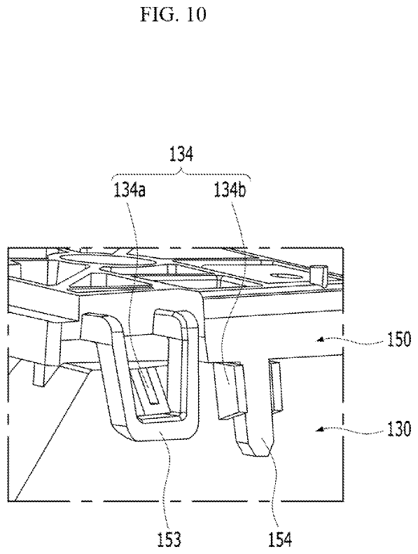

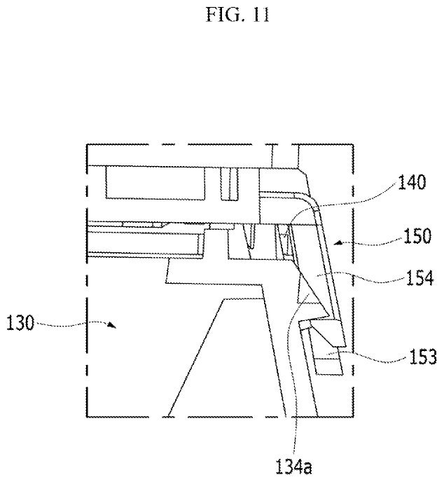

FIGS. 9 to 13 are views illustrating a state in which the folding mirror cover and the screen are coupled to each other with the folding mirror interposed therebetween in the head-up display for a vehicle according to the second embodiment of the present invention. FIG. 14 is a view illustrating the screen in the head-up display for a vehicle according to the second embodiment of the present invention.

First, referring to FIGS. 9 to 13 together, the folding mirror cover 150 includes fixing latches 153 and fixing bars 154.

The fixing latch 153 is fitted on and coupled to the fixing step 134a and has a ring shape. The fixing latch 153 may be bent and formed to correspond to a portion of the screen 130 to which the fixing latch 153 is coupled.

A sequence of coupling the folding mirror cover 150 will be described based on a direction shown in FIG. 9.

First, the fixing latch 153 at a right side is fitted on and coupled to the fixing step 134a at a right side.

Second, a lower end of the folding mirror cover 150 is connected to a connection part disposed at a lower end of the screen 130.

Third, the fixing latch 153 at a left side is fitted on and coupled to the fixing step 134a at a left side.

In this case, the folding mirror cover 150 and the screen 130 are in surface contact with each other in the first and second sequences above and are in line contact with each other in the third sequence.

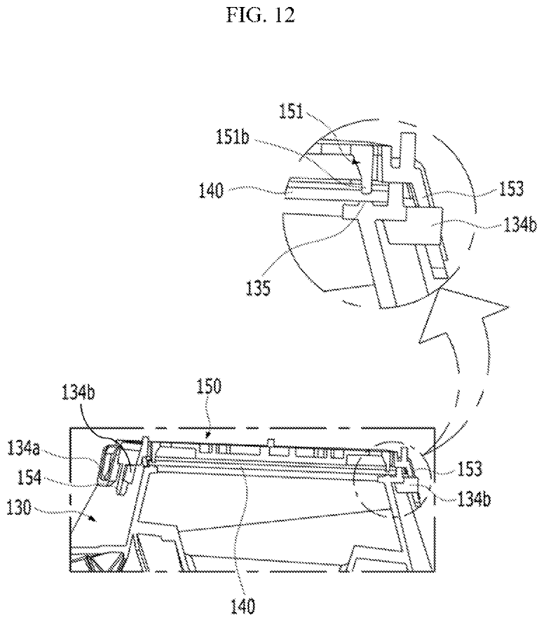

Meanwhile, as shown in FIGS. 12 to 14, the screen 130 includes a plurality of seating surfaces 135 that are disposed between the opening 131 and the stoppers 132 and are in surface contact with lower surfaces of side ends of the folding mirror 140.

In this case, a surface contact direction of the seating surface 135 is described as an example for ease of description, and when a portion, at which the folding mirror 140 and the folding mirror cover 150 are in contact with each other, is a lower surface of a side end, the surface contact direction of the seating surface 135 is a direction of an upper surface of the side end.

In other words, the surface contact direction of the seating surface 135 is only a direction opposite to the folding mirror cover 150 and is not limited to the upper surface or the lower surface.

An uneven portion (not shown) may be formed at a portion of the seating surface 135, which is in surface contact with the folding mirror 140, so as to have predetermined surface roughness.

The folding mirror cover 150 may include a pushing member 151 that is formed at a position facing the seating surface 135 and is in surface contact with the folding mirror 140.

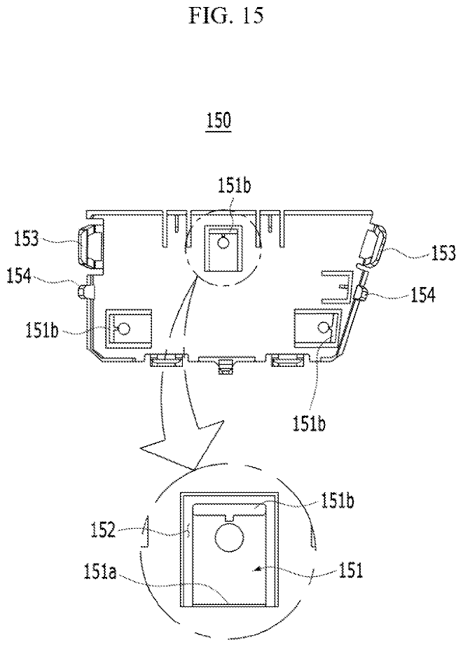

FIG. 15 is a view illustrating the folding mirror cover in the head-up display for a vehicle according to the second embodiment of the present invention.

Referring to FIG. 15, the folding mirror cover 150 has fixing holes 152 formed to pass therethrough at positions corresponding to the seating surfaces 135.

In this case, the pushing member 151 is connected to a lower end of the fixing hole 152. The pushing member 151 may reciprocate in a forward direction toward the seating surface 135 and a rearward direction opposite to the seating surface 135.

That is, the pushing member 151 has a shape in which an upper end of the pushing member 151 is movable in forward and rearward directions of the fixing hole 152 in a state in which a lower end thereof is fixed to the fixing hole 152.

The pushing member 151 includes a fixing part 151a and a pressing part 151b.

The fixing part 151a is connected to the lower end of the fixing hole 152.

The pressing part 151b is formed to extend from the fixing part 151a. The pressing part 151b may reciprocate in the forward and rearward directions of the fixing hole 152 in a state in which the fixing part 151a is fixed to the fixing hole 152.

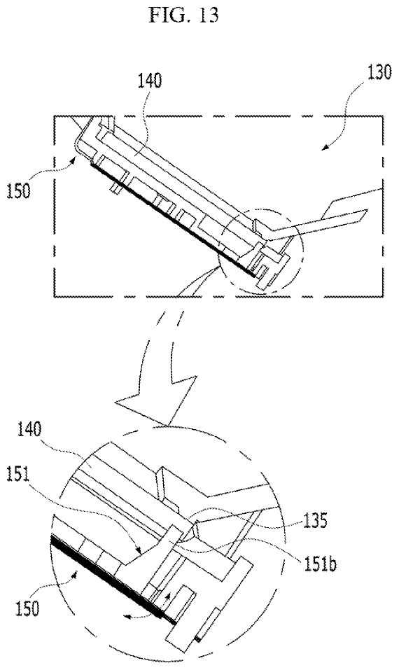

In this case, the pressing part 151b may be in surface contact with the folding mirror (see 140 of FIG. 13).

Meanwhile, the folding mirror cover 150 provides dimension measurement surfaces (not shown) in three areas thereof in order to facilitate dimension measurement. Here, the dimension measurement surfaces in the three areas may be formed at an interval in partial sections of an upper end portion and side portions of the folding mirror cover 150 in which the pushing members 151 are formed.

### Third Embodiment

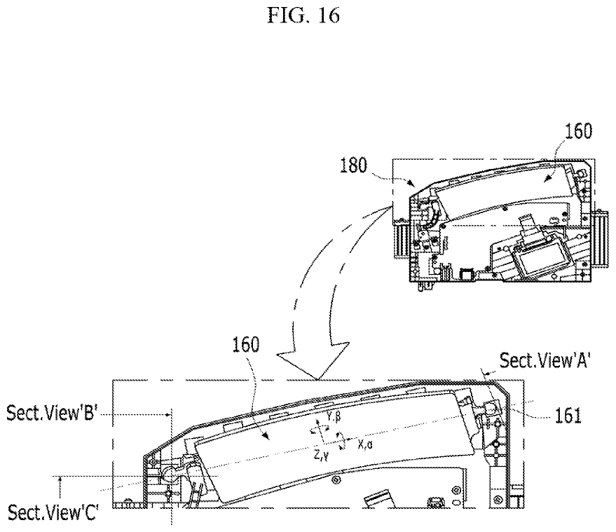

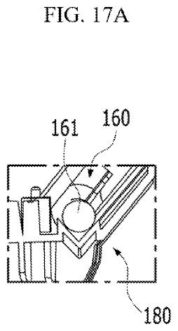

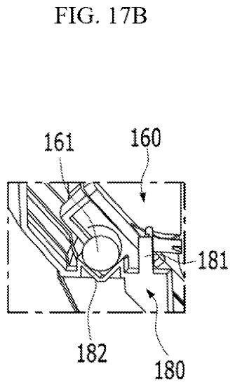

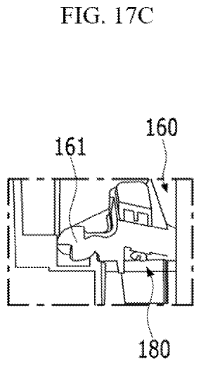

FIGS. 16 and 17A to 17C are views illustrating a mounting state between an aspheric mirror and a lower case in a head-up display for a vehicle according to a third embodiment of the present invention.

Referring to FIGS. 16 and 17A to 17C together, an aspheric mirror 160 includes spherical mounts 161 formed at both ends thereof so as to be rotatably connected to a lower case 180.

The lower case 180 includes a V block formed at a portion corresponding to the spherical mount 161. In this case, x, y, and z-axis rotation directions and β and γ rotation directions of the aspheric mirror 160 are constrained. That is, the aspheric mirror 160 is allowed to be rotated only in an a rotation direction.

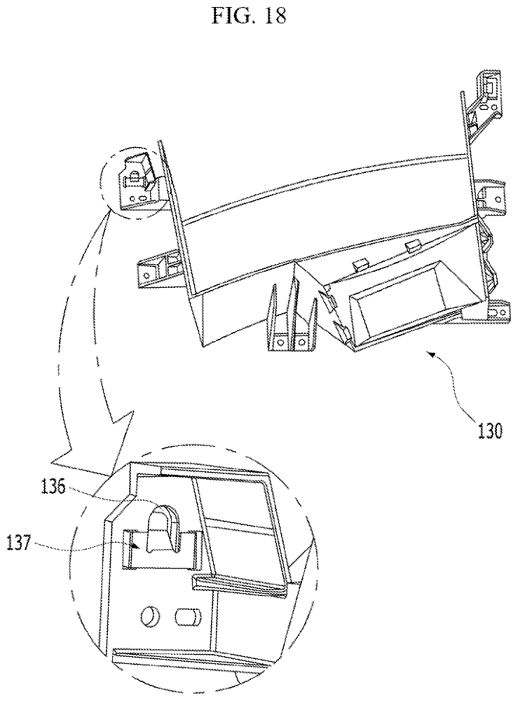

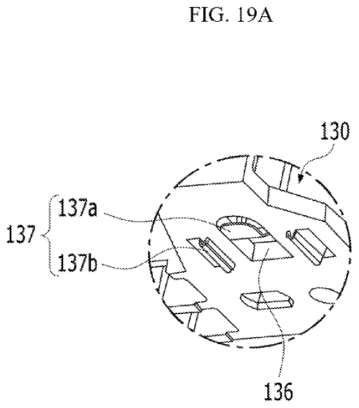

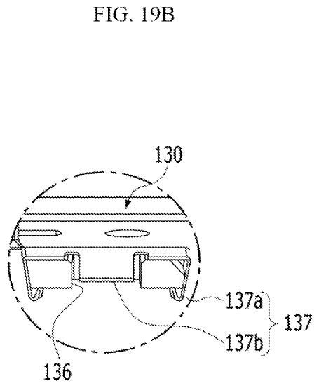

FIGS. 18 and 19A to 19B are views illustrating a state in which a leaf spring is mounted on a screen in the head-up display for a vehicle according to the third embodiment of the present invention.

Referring to FIGS. 18 and 19A to 19B together, a screen 130 is connected to the lower case (see 180 of FIGS. 16 and 17A to 17C).

In this case, the screen 130 is provided with a leaf spring 137 in order to limit a displacement of the spherical mount (see 161 of FIGS. 16 and 17A to 17C) of the aspheric mirror (see 160 of FIGS. 16 and 17A to 17C).

The leaf spring 137 has a snap-fit coupling structure detachably coupled to a coupling hole 136 formed in the screen 130.

The leaf spring 137 includes a pressing portion 137a and a hook portion 137b.

The pressing portion 137a is a portion that protrudes downward from the coupling hole 136 by a predetermined interval and is in direct contact with the spherical mount (see of 161 in FIGS. 16 and 17A to 17C).

The hook portion 137b is snap-fit-coupled to the coupling hole 136 so that the leaf spring 137 is firmly fixed to the coupling hole 136.

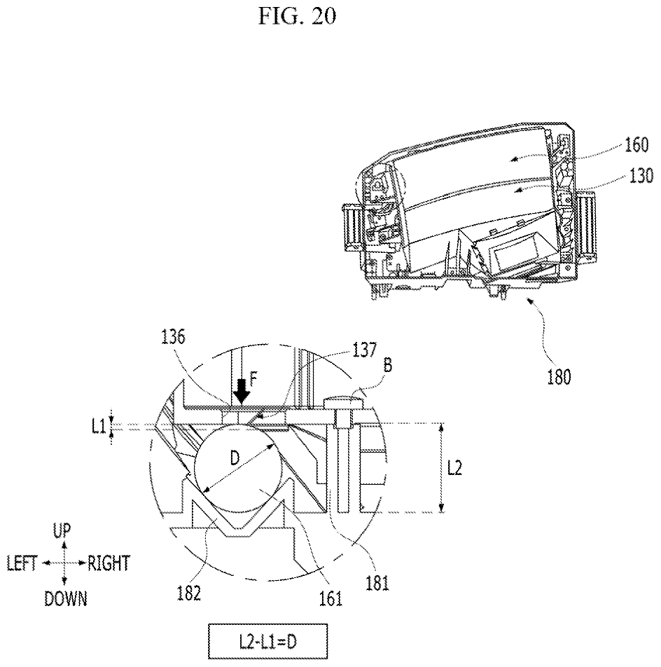

FIG. 20 is a view illustrating a state in which the screen mounted with the leaf spring and the lower case are coupled to each other with the aspheric mirror interposed therebetween in the head-up display for a vehicle according to the third embodiment of the present invention.

Referring to FIG. 20, the leaf spring 137 of the screen 130 limits the displacement of the spherical mount 161 of the aspheric mirror 160 with a predetermined fixing force.

In this case, the lower case 180 has a vertical coupling groove 181 having a height L2 relatively greater than a diameter D of the spherical mount 161.

The vertical coupling groove 181 is bolt-coupled to the screen 130.

The lower case 180 includes a seating block 182 positioned to be vertically collinear with the leaf spring 137 with the spherical mount 161 interposed therebetween.

The seating block 182 seats the aspheric mirror 160 under the aspheric mirror 160 to have a function of preventing a gap from occurring at a joint of the aspheric mirror 160 and also allowing the aspheric mirror 160 to be rotated only in a rotation direction.

That is, the seating block 182 serves to prevent a gap from occurring when the spherical mount 161 rotates.

Accordingly, the seating block 182 has a shape corresponding to the spherical mount 161. For example, the seating block 182 may have a shape such as a “V” shape capable of stably seating the spherical mount 161 under the spherical mount 161.

Here, the leaf spring 137 protrudes in a direction, in which the leaf spring 137 is in contact with the spherical mount 161, by as much as a difference between the height L2 of the vertical coupling groove 181 and the diameter D of the spherical mount 161.

That is, the leaf spring 137 fixes the spherical mount 161 with a force F corresponding to a protruding length L1.

In other words, when the screen 130 to which the leaf spring 137 is assembled is coupled to the lower case 180 using a bolt B, unless an amount of impact is applied sufficiently to damage the bolt coupling, the spherical mount 161 of the aspheric mirror 160 is moved only by as much as the protruding length L1.

Here, the force F corresponding to the protruding length L1, which is an overlap amount of the leaf spring 137, acts as a fixing force for the aspheric mirror 160.

As described above, according to the present invention, a coupling structure between a screen, and a folding mirror and a folding mirror cover can be improved to prevent the deformation of the folding mirror.

In particular, according to the present invention, a snap-fit structure is applied between the screen and the folding mirror to form an integrated structure, thereby providing an improved coupling structure.

In addition, the present invention provides a structure capable of coupling a folding mirror according to the presence or absence of a folding mirror cover.

In this case, when the folding mirror cover is present, the push position of the folding mirror coincides with a seating surface of the folding mirror. Accordingly, the deformation of the folding mirror can be prevented, thereby preventing the distortion of a head-up display (HUD) image.

On the other hand, when the folding mirror cover is not present, the folding mirror is formed in response to the absent of the folding mirror cover, thereby reducing costs.

In addition, according to the present invention, unless an amount of impact is applied sufficiently to damage bolt coupling, a displacement of the aspheric mirror is limited by as much as an overlap amount of a leaf spring, thereby effectively fixing a fixed portion of the aspheric mirror without a gap.

The present invention is not limited to the above-described embodiments and can be variously modified and implemented without departing from the scope and spirit of the present invention.

What is claimed is:

1. A head-up display for a vehicle having an improved coupling structure, the head-up display comprising:
a screen; and
a folding mirror snap-fit-coupled to the screen.

2. The head-up display of claim 1, wherein the screen includes:
an opening passing through a portion thereof connected to the folding mirror;
stoppers disposed around the opening to hold side surfaces of the folding mirror; and
fixing holders disposed at peripheries of the stoppers to hold an upper surface, a lower surface, and a side surface of the folding mirror.

3. The head-up display of claim 2, wherein a portion of the fixing holder protrudes inward toward the opening and is forcibly fitted into the folding mirror.

4. The head-up display of claim 3, wherein the fixing holder has a “┐” shape in which an upper end thereof is gradually inclined toward a lower portion thereof.

5. The head-up display of claim 3, wherein the fixing holder has a shape in which an upper end thereof is gradually inclined toward a lower portion thereof, and a portion thereof is configured to hold the folding mirror is formed in a “⊏” shape so as to fix a side end of the folding mirror.

6. The head-up display of claim 5, wherein the fixing holder includes:
an upper frame configured to hold the upper surface of the folding mirror;
a side frame configured to hold the side surface of the folding mirror; and
a lower frame configured to hold the lower surface of the folding mirror.

7. The head-up display of claim 6, wherein an upper end of the upper frame has a chamfered structure.

8. A head-up display for a vehicle having an improved coupling structure, the head-up display comprising:
a screen including an opening of which one side is open, a plurality of stoppers disposed around the opening, and a plurality of seating surfaces disposed between the opening and the stoppers;
a folding mirror cover snap-fit-coupled to the screen in a form which covers the opening; and
a folding mirror fixed between the screen and the folding mirror cover and in which a lower end portion of a side surface thereof is in surface contact with the seating surface in a state in which a side end thereof is fixed by the stopper.

9. The head-up display of claim 8, wherein the folding mirror cover includes a pushing member formed at a position facing the seating surface and in surface contact with the folding mirror.

10. The head-up display of claim 9, wherein:
the folding mirror cover has a fixing hole passing therethrough at a position corresponding to the seating surface; and
the pushing member is connected to a lower end of the fixing hole and reciprocates in a forward direction toward the seating surface and a rearward direction opposite to the seating surface.

11. The head-up display of claim 10, wherein:
the pushing member includes a fixing part connected to the lower end of the fixing hole, and a pressing part which is formed to extend from the fixing part and reciprocates in the forward and backward directions of the fixing hole in a state of being fixed to the fixing hole; and
the pressing part is in surface contact with the folding mirror.

12. A head-up display for a vehicle having an improved coupling structure, the head-up display comprising:
a lower case;
an aspheric mirror including spherical mounts formed at both ends thereof so as to be rotatably connected to the lower case; and
a screen connected to the lower case and including a leaf spring configured to limit a displacement of the spherical mount with a predetermined fixing force.

13. The head-up display of claim 12, wherein:
the lower case includes a vertical coupling groove having a height greater than a diameter of the spherical mount; and
the vertical coupling groove is bolt-coupled to the screen.

14. The head-up display of claim 13, wherein the lower case includes a seating block positioned to be vertically collinear with the leaf spring with the spherical mount interposed therebetween and having a “V” shape so as to seat the spherical mount under the spherical mount.

15. The head-up display of claim 14, wherein the vertical coupling groove is integrally formed and collinear with the lower case in a state of being spaced apart from the lower case.

16. The head-up display of claim 12, wherein the lower case includes a seating block positioned to be vertically collinear with the leaf spring with the spherical mount interposed therebetween, is disposed under the spherical mount to seat the spherical mount, and has a shape corresponding to the spherical mount so that a gap does not occur with the spherical mount.

17. The head-up display of claim 13, wherein the leaf spring fixes the spherical mount by protruding in a direction in which the leaf spring is in contact with the spherical mount, by as much as a difference between the height of the vertical coupling groove and the diameter of the spherical mount.

18. The head-up display of claim 12, wherein the leaf spring has a snap-fit coupling structure detachably coupled to a coupling hole formed in the screen.
